(19) United States
(12) Patent Application Publication
(10) Pub. No.: US 2009/0097058 A1
(43) Pub. Date: Apr. 16, 2009

(54) IMAGE FORMING APPARATUS, HOST APPARATUS CONNECTED THERETO AND IMAGE PROCESSING METHOD THEREOF

(75) Inventor: In-hwan CHO, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/235,672

(22) Filed: Sep. 23, 2008

(30) Foreign Application Priority Data
Oct. 10, 2007 (KR) 2007-102177

(51) Int. Cl. G06F 3/12

(52) U.S. Cl. 358/1.15

(57) ABSTRACT

A host apparatus to transmit image data on a task object to an image forming apparatus, and the host apparatus includes a user input unit to receive a user's selection for a plurality of task options to perform a plurality of tasks for a single task object, a host communication unit to perform communication with the image forming apparatus; and a host controller to control the host communication unit to generate a single set of image data corresponding to the plurality of task options and transmit the single set of image data to the image forming apparatus. The image forming apparatus receives image data corresponding to a task object from a host apparatus, and the image forming apparatus includes a print communication unit to perform communication with the host apparatus, and a print controller to interpret information corresponding to a plurality of task options included in the image data received through the print communication unit in a unit of page.

### CROSS-REFERENCE TO RELATED APPLICATIONS

This application claims priority under 35 U.S.C. §119(a) from Korean Patent Application No. 10-2007-0102177, filed on Oct. 10, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus to perform a plurality of tasks for a document, a host apparatus connected thereto and an image processing method thereof.

2. Description of the Related Art

In general, an image forming system includes an image forming apparatus and a host apparatus which are connected with each other. The host apparatus generates image data and transmits the image data to the image forming apparatus. The image forming apparatus forms an image based on the image data.

The host apparatus may set up various types of tasks for a task object, that is, a document according to a user's selection. For example, a user may want to perform printing together with a fax communication.

In this case, according to a conventional method, a plurality of image data are individually generated and transmitted for the respective tasks. For example, the host apparatus generates image data for printing and transmits the image data to the image forming apparatus, and then, generates image data for fax communication and transmits the image data to the image forming apparatus. The image data may include task option information for representing the type of image tasks.

Thus, a plurality of image data should be generated and repeatedly transmitted when performing a plurality of tasks for a single document, thereby increasing processing time and causing inconvenience to a user.

### SUMMARY OF THE INVENTION

The present invention provides a host apparatus to generate a single set of image data for a plurality of task options and transmit the image data to an image forming apparatus, an image processing method thereof, and the image forming apparatus connected to the host apparatus.

Additional aspects of the present general inventive concept will be set forth in part in the description which follows and, in part, will be obvious from the description, or may be learned by practice of the present general inventive concept.

The foregoing and/or other aspects and utilities of the present general inventive concept can be achieved by providing an image processing method in a host apparatus to transmit image data to an image forming apparatus, the method including setting up a plurality of task options to perform a plurality of tasks for a single task object, generating a single set of image data corresponding to the plurality of task options, and transmitting the single set of image data to the image forming apparatus.

The image data may include a header which includes information on the plurality of task options.

The task options may be set up in a unit of page for the task object.

The image processing method may further include receiving information corresponding to task options which are supported by the image forming apparatus from the image forming apparatus.

The image processing method may further include displaying a user interface (UI) for a user's selection for the plurality of task options.

The UI may include a page set-up menu corresponding to the respective task options.

The image forming apparatus may interpret the information corresponding to the plurality of task options according to a page identification (ID) given to the image data, and may perform the plurality of tasks based on the interpreted information on the task options.

The foregoing and/or other aspects and utilities of the present general inventive concept can be also achieved by providing a host apparatus to transmit image data on a task object to an image forming apparatus, the host apparatus including a user input unit to receive a user's selection for a plurality of task options to perform a plurality of tasks for a single task object, a host communication unit to perform communication with the image forming apparatus, and a host controller to control the host communication unit to generate a single set of image data corresponding to the plurality of task options and transmit the single set of image data to the image forming apparatus.

The image data may include a header which includes information on the plurality of task options.

The task options may be set up in a unit of page for the task object.

The host apparatus may further include a memory unit to store the single set of image data, and the host controller may receive information task options which are supported by the image forming apparatus from the image forming apparatus through the host communication unit and may store the received information in the memory unit.

The host apparatus may further include a user interface (UI) generating unit to generate a user interface (UI) for a user's selection for the plurality of task options.

The UI may include a page set-up menu corresponding to the respective task options.

The host apparatus may further include a display unit to display the UI.

The foregoing and/or other aspects and utilities of the present general inventive concept can be also achieved by providing an image forming apparatus to receive image data corresponding to a task object from a host apparatus, the image forming apparatus including a print communication unit to perform communication with the host apparatus, and a print controller to interpret information corresponding to a plurality of task options included in the image data received through the print communication unit in a unit of page.

The print controller may interpret the information corresponding to the task options according to a page identification (ID) given to the image data.

The image forming apparatus may further include a processing unit to perform tasks corresponding to the plurality of task options for the interpreted image data.

The foregoing and/or other aspects and utilities of the general inventive concept may also be achieved by providing a host apparatus usable with an image forming apparatus, the host apparatus including a host communication unit to generate and transmit a single set of image data corresponding to a plurality of task options to the image forming apparatus, wherein the single set of image data is used to perform a single task object.

The foregoing and/or other aspects and utilities of the general inventive concept may also be achieved by providing an image forming apparatus usable with a host apparatus, the image forming apparatus including a print controller to interpret information corresponding to a plurality of task options in a single set of image data received from the host apparatus, wherein the plurality of tasks are performed on a single task object based on the interpreted information.

The foregoing and/or other aspects and utilities of the general inventive concept may also be achieved by providing an image forming system including a host apparatus including a communication unit to generate and transmit a single set of image data corresponding to a plurality of task options to an image forming apparatus, and an image forming apparatus including a print controller to interpret information corresponding to the plurality of task options in the single set of image data received from the host apparatus, wherein the plurality of tasks are performed on a single task object based on the interpreted information.

The foregoing and/or other aspects and utilities of the general inventive concept may also be achieved by providing an image forming method including generating a single set of image data by a host apparatus corresponding to a plurality of task options, transmitting the generated single set of image data by the host apparatus to an image forming apparatus, and interpreting information by the image forming apparatus corresponding to the plurality of task options in the single set of image data received from the host apparatus, and performing a plurality of tasks on a single task object based on the interpreted information.

The foregoing and/or other aspects and utilities of the general inventive concept may also be achieved by providing a computer-readable recording medium having embodied thereon a computer program to execute a method, wherein the method includes generating a single set of image data by a host apparatus corresponding to a plurality of task options, transmitting the generated single set of image data by the host apparatus to an image forming apparatus, and interpreting information by the image forming apparatus corresponding to the plurality of task options in the single set of image data received from the host apparatus, and performing a plurality of tasks on a single task object based on the interpreted information.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is a block diagram illustrating an image forming system which includes a host apparatus and an image forming apparatus according to an exemplary embodiment of the present general inventive concept;

FIGS. 2A to 2D illustrate an example of a user interface (UI) generated through a UI generating unit of the host apparatus in FIG. 1;

FIG. 3 illustrates an example of image data of a PJL (Printer Job Language) format;

FIG. 4 illustrates an example of image data interpreted by the image forming apparatus in FIG. 1; and

FIGS. 5 and 6 are flowcharts illustrating an image processing method according to an exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The exemplary embodiments are described below so as to explain the present general inventive concept by referring to the figures.

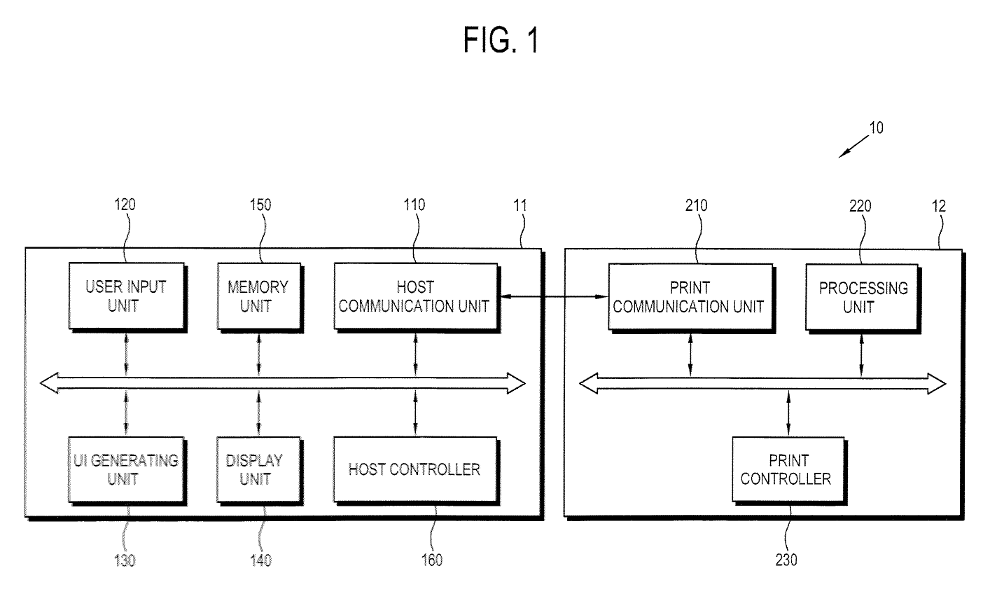

FIG. 1 illustrates a host apparatus 11 and an image forming apparatus 12 according to an exemplary embodiment of the present general inventive concept. The host apparatus 11 and the image forming apparatus 12 are connected to each other. The host apparatus 11 may be provided as a personal computer or the like to generate and transmit image data. The image forming apparatus 12 may be provided as a printer, a multi function devices or the like which can support a plurality of task options. The present general inventive concept may be embodied into an image forming system 10 which includes the host apparatus 11 and the image forming apparatus 12.

As illustrated in FIG. 1, the host apparatus 11 includes a host communication unit 110, a user input unit 120, a UI generating unit 130, a display unit 140, a memory unit 150 and a host controller 160.

The host communication unit 110 performs data communication with the image forming apparatus 12 under the control of the host controller 160. The host communication unit 110 may receive information on task options which can be supported by the image forming apparatus 12. The host communication unit 110 may be provided as a wire or wireless communication module which is network-accessible, a USB port or the like.

The user input unit 120 receives a user's selection for a plurality of task options. Here, the task options, for example, refer to options for tasks which can be supported by the image forming apparatus 12. For example, the image forming apparatus 12 may support printing options including general printing, proof printing, security printing, printing as an image, delay printing, fax transmission, etc., and different task options including printing paper set-up, fax receiver set-up, etc., which can be set up by a user, for a document.

The UI generating unit 130 generates a user interface (UI) for the user's selection for a plurality of task options which can be supported by the image forming apparatus 12 under the control of the host controller 160.

The UI generated through the UI generating unit 130 may be displayed to a user through the display unit 140.

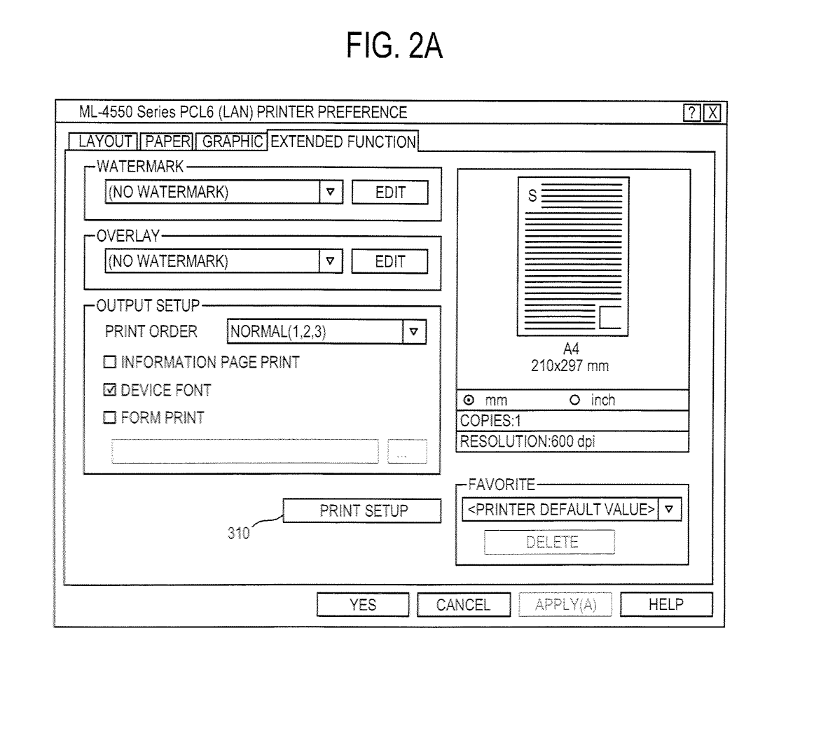

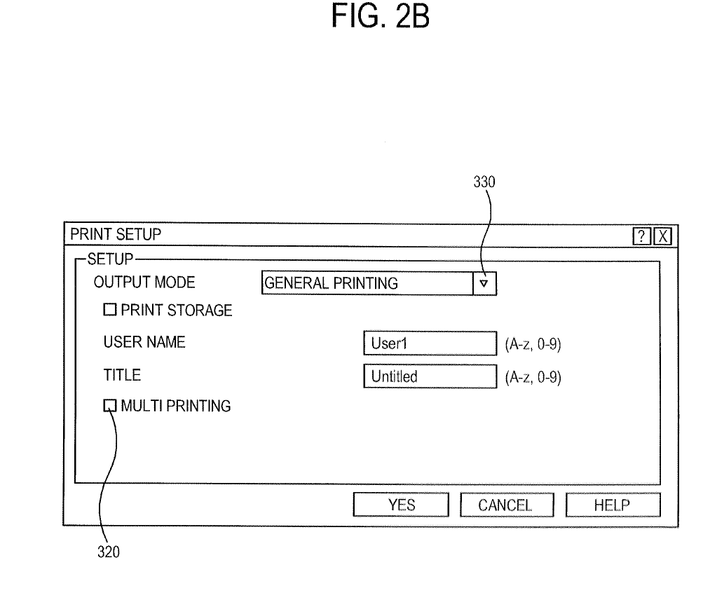

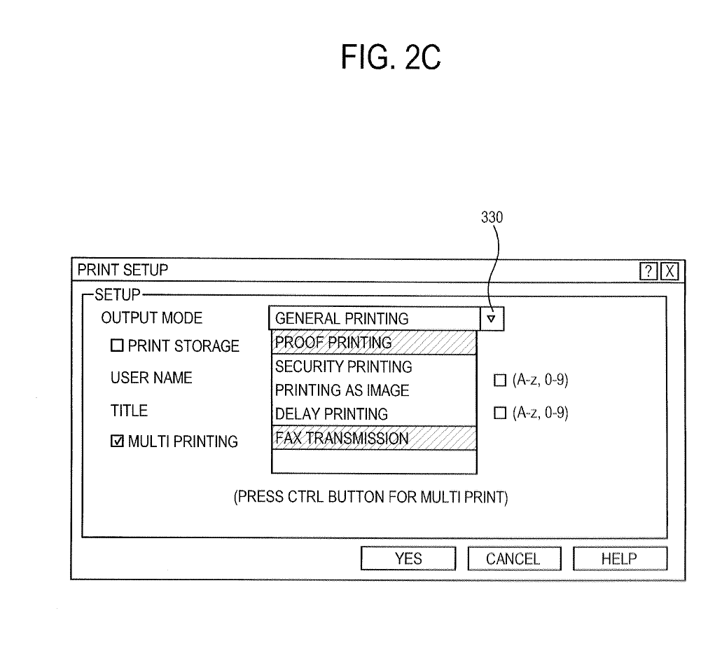

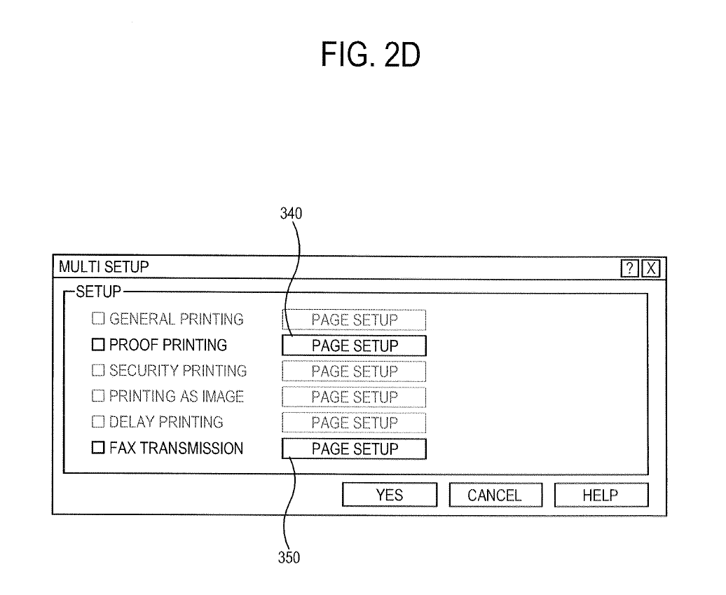

FIG. 2A through FIG. 2D illustrate an example of the UI generated through the UI generating unit 130.

As illustrated, the UI may include a task set-up button 310, a plurality of task option check boxes 320, a task option add button 330, and a plurality of page set-up buttons 340 and 350 for every task option. That is, the UI may include page set-up menus corresponding to the respective task options for a document.

For example, a user may select the task set-up button 310 as illustrated in FIG. 2A to perform printing. Then, as illustrated in FIG. 2B, a menu including the plurality of task option check boxes 320 is activated. If the menu is checked, the plurality of task options can be selected through the task option add button 330. Then, the user may set up a page corresponding to every task option through the page set-up buttons 340 and 350 activated for every task option.

In the memory unit 150 are stored information on a plurality of task options which are supported by the image forming apparatus 12, the information being transmitted through the host communication unit 110, image data corresponding to the plurality of task options set-up by the user, and the like. The memory unit 150 may be provided as an HDD, a RAM, etc., and stores image data which is set up for a task option in a file format.

The host controller 160 controls entire operations of the host apparatus 11. Specifically, the host controller 160 controls the host communication unit 110 to generate single image data corresponding to the plurality of task options which are input through the user input unit 120 and transmits the image data to the image forming apparatus 12 through the host communication unit 110.

Here, the generated image data includes a header including information on the plurality of task options. The header may be made in the PJL format (Printer Job Language). The task option can be set up in a unit of page of the document.

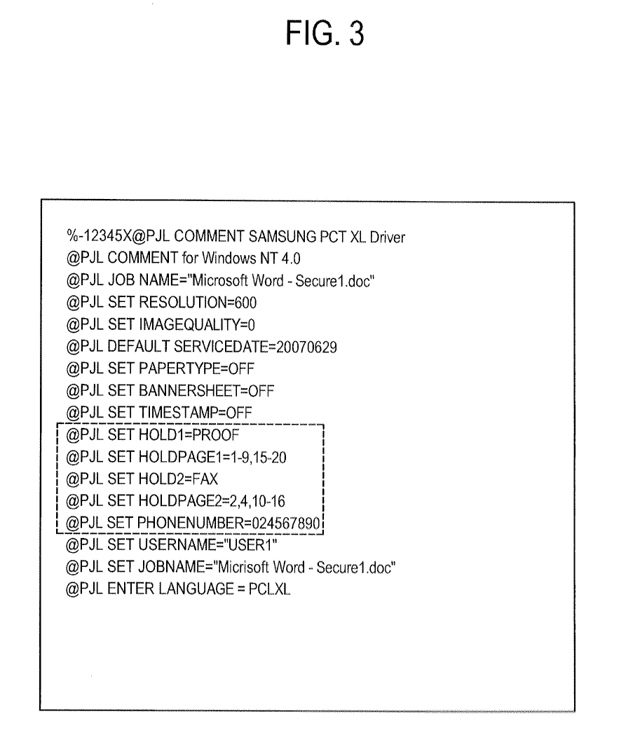

FIG. 3 illustrates an example of the header of the image data of the PJL format. As illustrated, the image data includes page set-up information for every page for the plurality of task options. For example, a user may set up proof printing for pages 1 through 9 and 15 through 20 and may set up fax transmission for pages 2, 4 and 10 through 16. In this case, one image data generated include information on the plurality of task options in the header thereof.

Alternatively, as illustrated in FIG. 1, the image forming apparatus 12 includes a print communication unit 210, a processing unit 220 and a print controller 230.

The print communication unit 210 performs data communication with the host apparatus 11 under the control of the print controller 230. That is, the print communication unit 210 may transmit the task option information to the image forming apparatus 12 in response to request of the host apparatus 11. The print communication unit 210 may be provided as a wire or wireless communication module which is network-accessible, a USB port or the like.

The processing unit 220 forms an image based on the image data received from the host apparatus 11, and performs tasks corresponding to the plurality of task options included in the image data.

The print controller 230 controls the entire operations of the image forming apparatus 12. Specifically, the print controller 230 interprets the task option information included in the image data received from the host apparatus 11, for every page.

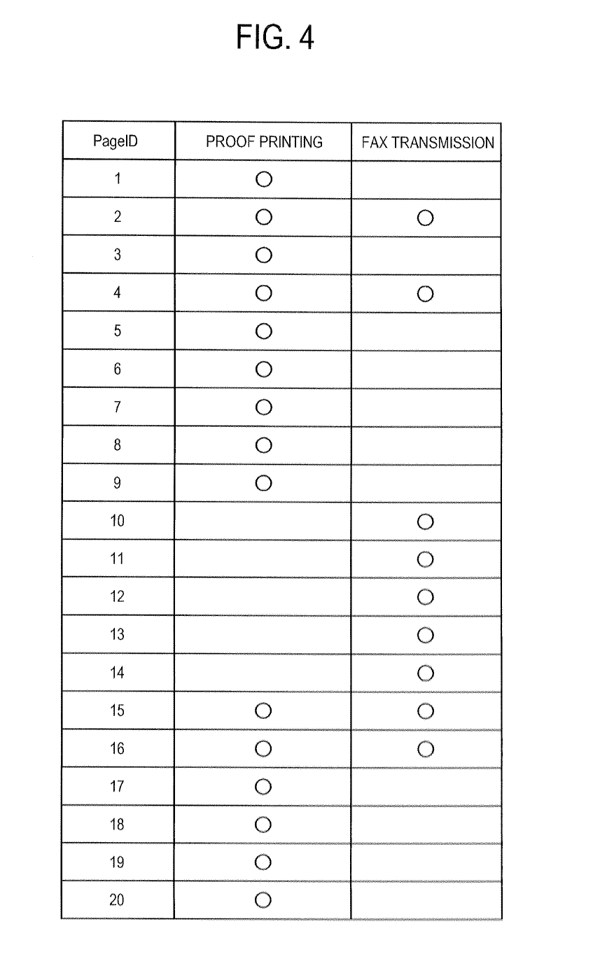

FIG. 4 illustrates an example of the image data interpreted by the image forming apparatus 12.

The image forming apparatus 12 interprets the task option information according to a page ID given to the received image data. For example, in the case that proof printing is set up for pages 1 through 9 and 15 through 20 and fax transmission is set up for pages 2, 4 and 10 through 16 in the host apparatus 11 as illustrated in FIG. 3, the image forming apparatus 12 receives the image data concerned and interprets set-up for the plurality of task options for every page according to the page ID given every page as illustrated in FIG. 4.

Here, if the header of the received image data is made in the PJL format, the print controller 230 can perform PJL-parsing for the header of the received image data to interpret the plurality of task options.

Then, the print controller 230 controls the processing unit 220 to perform operations corresponding to the interpreted task options.

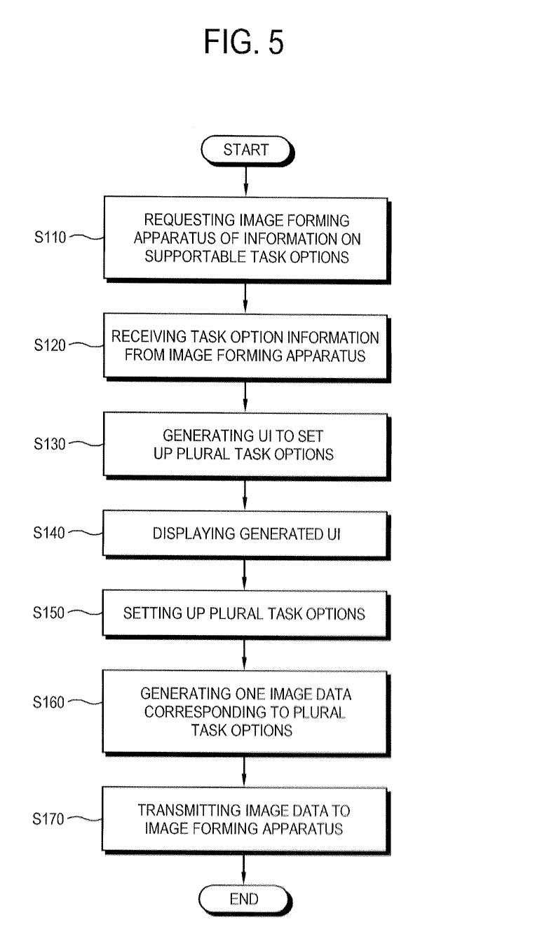

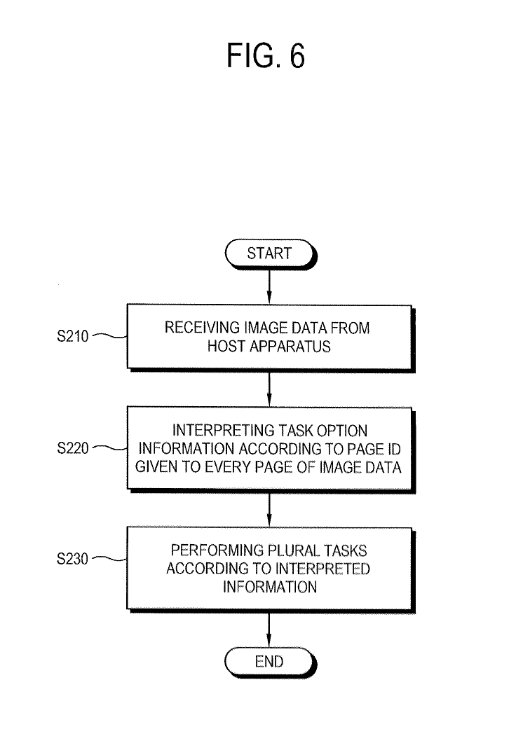

Hereinafter, an image processing method in the host apparatus 11 and the image forming apparatus 12 as configured above will be described with reference to FIGS. 5 and 6.

The host apparatus 11 requests the image forming apparatus 12 of task option information (operation S110) and receives the task option information from the image forming apparatus 12 (operation S120).

The host apparatus 11 generates a UI for a user's selection for a plurality of task options received at operation S120 (operation S130).

The host apparatus 11 displays the UI to a user (operation S140). Here, the UI may include a page set-up menu corresponding to every task option.

The host apparatus 11 receives a user's selection through the UI and sets up the plurality of task options for a single task object, that is, one document (operation S150).

The host apparatus 11 generates single image data corresponding to the set-up task options (operation S160). Here, the generated image data may have the PJL format, including a header which includes information on the plurality of task options. The task option may be set up in the unit of page of the document.

The host apparatus 11 transmits the image data to the image forming apparatus 12 (operation S170).

Alternatively, referring to FIG. 6, the image forming apparatus 12 receives the image data including information on the plurality of task options from the host apparatus 11 (operation S210).

The image forming apparatus 12 interprets the task option information according to a page ID given to the received image data (operation S220). Here, if the image data is in the PJL format, the image forming apparatus 12 may perform PJL parsing to interpret the task option information.

The image forming apparatus 12 forms an image based on the image data according to the interpreted task option information, and performs a plurality of tasks corresponding thereto (operation S230).

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to various embodiments of the present general inventive concept, single image data can be generated for a plurality of task options and then transmitted to an image forming apparatus, thereby decreasing processing time and improving a user's convenience.

Although various exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image processing method of a host apparatus to transmit image data to an image forming apparatus, the method comprising:
setting up a plurality of task options to perform a plurality of tasks for a single task object;
generating a single set of image data corresponding to the plurality of task options; and
transmitting the single set of image data to the image forming apparatus.

2. The image processing method according to claim 1, wherein the image data comprises:
a header which comprises information corresponding to the plurality of task options.

3. The image processing method according to claim 1, wherein the task options are set up in a unit of page for the task object.

4. The image processing method according to claim 1, further comprising:
receiving information corresponding to task options which are supported by the image forming apparatus from the image forming apparatus.

5. The image processing method according to claim 1, further comprising:
displaying a user interface (UI) for a user's selection for the plurality of task options.

6. The image processing method according to claim 5, wherein the UI comprises:
a page set-up menu corresponding to every task option.

7. The image processing method according to claim 1, wherein the image forming apparatus interprets the information corresponding to the plurality of task options according to a page identification (ID) given to the image data, and performs the plurality of tasks based on the interpreted information on the task options.

8. A host apparatus to transmit image data on a task object to an image forming apparatus, the host apparatus comprising:
a user input unit to receive a user's selection for a plurality of task options to perform a plurality of tasks for a single task object;
a host communication unit to perform communication with the image forming apparatus; and
a host controller to control the host communication unit to generate a single set of image data corresponding to the plurality of task options and transmit the single set of image data to the image forming apparatus.

9. The host apparatus according to claim 8, wherein the image data comprises:
a header which comprises information corresponding to the plurality of task options.

10. The host apparatus according to claim 8, wherein the task options are set up in a unit of page for the task object.

11. The host apparatus according to claim 8, further comprising:
a memory unit to store the single set of image data, wherein the host controller receives information corresponding to the task options which are supported by the image forming apparatus from the image forming apparatus through the host communication unit and stores the received information in the memory unit.

12. The host apparatus according to claim 8, further comprising:
a user interface (UI) generating unit to generate a UI for a user's selection for the plurality of task options.

13. The host apparatus according to claim 12, wherein the UI comprises:
a page set-up menu corresponding to the respective task options.

14. The host apparatus according to claim 13, further comprising:
a display unit to display the UI.

15. An image forming apparatus to receive image data on a task object from a host apparatus, the image forming apparatus comprising:
a print communication unit to perform communication with the host apparatus; and
a print controller to interpret information corresponding to a plurality of task options included in the image data received through the print communication unit in a unit of page.

16. The image forming apparatus according to claim 15, wherein the print controller interprets the information corresponding to the task options according to a page identification (ID) given to the image data.

17. The image forming apparatus according to claim 15, further comprising:
a processing unit to perform tasks corresponding to the plurality of task options for the interpreted image data.

18. An image forming system, comprising:
a host apparatus including a communication unit to generate and transmit a single set of image data corresponding to a plurality of task options to an image forming apparatus; and
an image forming apparatus including a print controller to interpret information corresponding to the plurality of task options in the single set of image data received from the host apparatus;
wherein the plurality of tasks are performed on a single task object based on the interpreted information.

19. An image forming method, comprising:
generating a single set of image data by a host apparatus corresponding to a plurality of task options;
transmitting the generated single set of image data by the host apparatus to an image forming apparatus; and
interpreting information by the image forming apparatus corresponding to the plurality of task options in the single set of image data received from the host apparatus; and
performing a plurality of tasks on a single task object based on the interpreted information.

20. A computer-readable recording medium having embodied thereon a computer program to execute a method, wherein the method comprises:
generating a single set of image data by a host apparatus corresponding to a plurality of task options;
transmitting the generated single set of image data by the host apparatus to an image forming apparatus; and
interpreting information by the image forming apparatus corresponding to the plurality of task options in the single set of image data received from the host apparatus; and
performing a plurality of tasks on a single task object based on the interpreted information.
